(19) United States
(12) Patent Application Publication
(10) Pub. No.: US 2012/0327693 A1
(43) Pub. Date: Dec. 27, 2012

(54) HIGH VOLTAGE DIRECT CURRENT GENERATION AND TRANSMISSION BY A WIND TURBINE

(75) Inventors: Kevin L. Cousineau, Lompoc, CA (US); William L. Erdman, Moraga, CA (US); Peter Damon Stricker, Santa Barbara, CA (US)

(73) Assignee: Clipper Windpower, Inc.

(21) Appl. No.: 13/167,037

(22) Filed: Jun. 23, 2011

(51) Int. Cl. H02J 3/36; H02P 9/04

(52) U.S. Cl. 363/35; 290/44

(57) ABSTRACT

A wind turbine including a synchronous generator that converts rotary motion of a hub or rotor of the wind turbine to a variable frequency alternating current (AC) power. The wind turbine further includes a primary power system located within the wind turbine that transforms the variable frequency AC power to high voltage direct current (HVDC) power and provides the HVDC power to a load over an HVDC transmission line. A method corresponding to the flow of power through the wind turbine and a wind park comprised of a plurality of the wind turbines are also provided.

### BACKGROUND

The present exemplary embodiments relate to energy producing devices. They find particular application in conjunction with wind turbines, and will be described with particular reference thereto. However, it is to be appreciated that the present exemplary embodiments are also amenable to other like applications.

Wind turbines and/or wind parks generally make use of alternating current (AC) for distribution of power therefrom. However, in certain situations, such as long distance transmission of power, it may be appropriate to make use of high voltage direct current (HVDC) for power distribution.

HVDC generally requires fewer wires than AC. One reason is that HVDC does not include varying phases. Because fewer wires are required for transmission, it is generally more economical to run wires for HVDC. While savings may not be substantial for short distances, savings can be substantial for long distances. Also, there can be savings in connection with underground and/or under water applications.

Further, HVDC generally suffers lower electrical losses than AC. Therefore, HVDC is generally better suited for distribution of power over long distances, where line losses can be substantial.

In addition, the distribution of power using AC generally requires the use of sub-stations for power conversion. However, sub-stations may prove costly. A wind turbine and/or wind park making use of HVDC may advantageously eliminate substations and directly interface with an HVDC power grid.

The present disclosure contemplates new and improved systems and/or methods facilitating the efficient generation of HVDC from a wind park and/or a wind turbine.

### INCORPORATION BY REFERENCE

The disclosure of U.S. Pat. No. 7,042,110 for “Variable Speed Distribution Drive Train Wind Turbine System,” by Mikhail et al., filed Feb. 4, 2004, is hereby incorporated herein in its entirety.

### BRIEF DESCRIPTION

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

According to one aspect of the present disclosure, a wind turbine is provided. The wind turbine includes a synchronous generator that converts rotary motion of a hub or rotor of the wind turbine to variable frequency alternating current (AC) power. The wind turbine further includes a primary power system located within the wind turbine that transforms the variable frequency AC power to high voltage direct current (HVDC) power and provides the HVDC power to a load over an HVDC transmission line.

According to another aspect of the present disclosure, a method of generating high voltage direct current (HVDC) power from a wind turbine is provided. Variable frequency alternating current (AC) power is received from a synchronous generator of the wind turbine. The generator converts rotary motion of a hub or rotor of the wind turbine to the AC power. The variable frequency AC power is transformed to HVDC power within the wind turbine and the HVDC power is provided to an HVDC transmission line.

According to still another aspect of the present disclosure, a wind park is provided. The wind park includes a plurality of wind turbines. Each of the wind turbines includes a synchronous generator that converts rotary motion of a hub or rotor of the wind turbine to variable frequency alternating current (AC) power. Further, each of the wind turbines includes a primary power system located within the wind turbine that transforms the variable frequency AC power of the wind turbine to high voltage direct current (HVDC) power. The wind park further includes a feeder that receives the HVDC power from the wind turbines and feeds the received HVDC power to an HVDC transmission line.

### BRIEF DESCRIPTION OF THE DRAWINGS

The following description and drawings set forth certain illustrative implementations of the disclosure in detail, and these are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a schematic side elevated view of a wind turbine according to one embodiment of the present disclosure;

FIG. 2 is a block diagram of a wind turbine according to an embodiment of the present disclosure;

FIG. 3 is a schematic of an HVDC unit consisting of a high frequency step up transformer and a high voltage rectifier for a wind turbine according to an embodiment of the present disclosure;

FIG. 4 is a block diagram of a wind park according to an embodiment of the present disclosure; and,

FIG. 5 is a block diagram of a method of generating HVDC for a wind turbine according to an embodiment of the present disclosure.

### DETAILED DESCRIPTION

One or more embodiments or implementations of the present disclosure are hereinafter described in conjunction with the drawings, where like reference numerals are used to refer to like elements throughout, and where the various features are not necessarily drawn to scale.

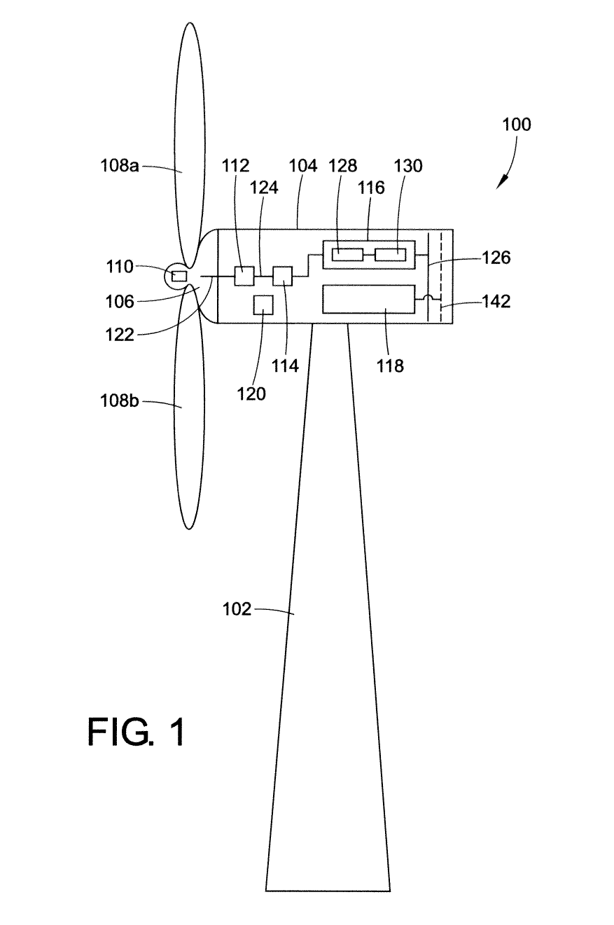

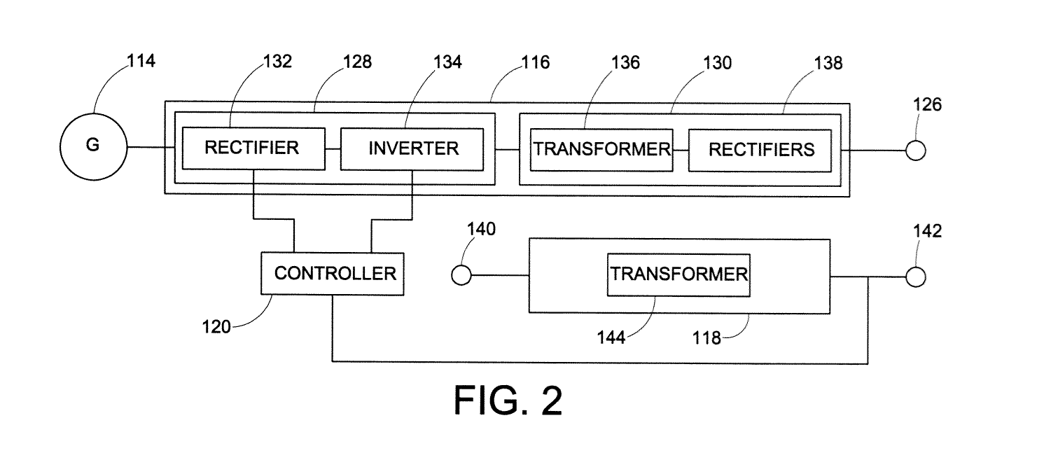

With reference to FIGS. 1 and 2, a schematic side elevated view of a wind turbine 100 and a block diagram thereof are illustrated, respectively. The wind turbine 100 is suitably a typical horizontal-axis, upwind-type wind turbine, but other types of wind turbines are equally amenable. For use with the instant disclosure, the wind turbine 100 may include one or more of a tower 102, a nacelle 104, a hub or rotor 106, one or more rotor blades 108, a pitch system 110, and the like.

The nacelle 104 suitably mounts to the top end of the tower 102, and the hub or rotor 106, bearing the rotor blades 108, suitably mounts to a lateral end of the nacelle 104. The rotor blades 108 may be adjusted by the pitch system 110, which is typically accommodated inside the hub or rotor 106. In certain embodiments, the pitch system 110 may control the rotor blades 108 based on pitch commands from another component of the wind turbine 100. The pitch system 110 may include one or more pitch drives (not shown) for adjusting the pitch of the rotor blades 108. Further, the pitch system 110 may include one or more pitch batteries (not shown) allowing the rotor blades 108 to be adjusted during periods of power loss. In certain embodiments, the pitch system 110 may include a pitch battery for each of the rotor blades 108.

The tower 102 and/or the nacelle 104 suitably house many of the components needed for operating the wind turbine 100, such as one or more of a gearbox 112, a generator 114, a primary power system 116, an accessory power system 118, a controller 120, and the like. The location of these components typically depends upon decisions from the manufacturer of the wind turbine 100 and how well these components fit within the tower 102 and/or the nacelle 104. For example, based on these dependencies, it is contemplated that the primary power system 116 may be located in the nacelle 104, as illustrated, or at the bottom of the tower 102 with the output of the generator 114 connected thereto via conductors strung down the tower 102.

The gearbox 112 suitably transfers mechanical energy from the hub or rotor 106 to the generator 114. The gearbox 112 may receive the mechanical energy via a first drive shaft 122, which is typically coupled to the hub or rotor 106. Further, the gearbox 112 may transfer the mechanical energy to the generator 114 via a second drive shaft 124, which is typically coupled to the generator 114. In certain embodiments, the gearbox 112 may transform the rotational speed of the first drive shaft 122, while transferring the mechanical energy received therefrom, to the second drive shaft 124. Therefore, in certain embodiments, the rotational speed of the second drive shaft 124 may vary as compared to the rotational speed of the first drive shaft 122.

The generator 114 is suitably synchronous and converts the mechanical energy of the rotor or hub 106 into alternating current (AC) power. The generator 114 may include at least one of one or more wound field synchronous generators, each with an exciter field excited with a constant current, one or more permanent magnet synchronous generators, and the like. The AC power of the generator 114 is typically larger than 500 kilovolt ampere (kVA) and may be even larger than 1 megavolt ampere (MVA). Further, the voltage and frequency of the AC power is typically dependent upon the speed of the hub or rotor 106.

The primary power system 116 transforms the AC power generated by the generator 114 into HVDC power, which may then be transferred via an HVDC utility grid and/or distribution line 126 for consumption by one or more consumers, such as businesses, individuals, and the like. As discussed below, the flow of power through the primary power system 116 and/or over the HVDC utility grid and/or distribution line 126 is suitably unidirectional. The primary power system 116 may include one or more of a conversion unit 128, an HVDC unit 130, and the like.

The conversion unit 128 transforms the AC power of the generator 114 into a high frequency AC power having a fixed voltage and fixed frequency. The frequency of the high frequency AC power is high in the sense that it is at least one or more orders of magnitude greater than the highest frequency of the AC power of the generator 114. For example, the frequency of the high frequency AC power is typically on the order of kilohertz, but may be even larger, such as on the order of megahertz, whereas the frequency of the AC power from the generator is on the order of a few hertz to a hectohertz. As noted above, the voltage and frequency of the generator's AC power is dependent upon the speed of the hub or rotor 106. Therefore, the fixed voltage is suitably maintained by controlling the speed of the hub or rotor 106 and through torque placed upon the generator by suitable current commands to the inverter.

To control the speed of the hub or rotor 106, the pitch of the rotor blades 108 may be controlled and/or the flow of current from the generator 114 may be controlled. Control of the pitch of the rotor blades is suitably carried out by providing the pitch system 110 with pitch commands identifying the desired pitch. Augmenting the pitch of the rotor blades 108 is well known to affect the speed of the hub or rotor 106. Control of the flow of current from the generator 114 is suitably carried out by providing an active component of the conversion unit 128 with current commands. Current commands instruct this component to limit the flow of current from the generator 114, which affects the speed of the hub or rotor 106 since current from the generator 114 is directly related to the torque and load of the wind turbine 100. It is contemplated that the pitch commands and/or the current commands are provided by a component of the conversion unit 128 or a component of the wind turbine 100 external to the conversion unit 128, such as the controller 120.

The conversion unit 128 suitably includes a rectifier 132, a high frequency inverter 134, and the like, as shown in FIG. 2, to transform the variable voltage and variable frequency AC power of the generator 114 to the high frequency AC power having the fixed voltage and a fixed frequency. However, more or less components are components and different arrangements of components are contemplated.

The rectifier 132 converts the variable frequency and variable voltage AC power of the generator 114 to DC. In preferred embodiments, the rectifier 132 is a passive rectifier including one or more diodes. As should be appreciated, this limits the flow of current from the generator 114 to a unidirectional flow. In other embodiments, the rectifier 132 is an active rectifier including one or more transistors. For example, it is contemplated that the active rectifier is an inverter serving as a rectifier. In both embodiments, the DC power is maintained at the fixed voltage by controlling the speed of the hub or rotor 106. However, the approach to doing so varies. In embodiments employing the active rectifier, the active rectifier may be employed to control the flow of current from the generator 114. In embodiments employing the passive rectifier, the high frequency inverter may be used to control the flow of current from the generator 114 since the passive rectifier is passive and cannot be used to do so.

The high frequency inverter 134 converts the DC power of the rectifier 132 to the high fixed frequency AC power. In certain embodiments, such as when the rectifier 132 is a passive rectifier, the high frequency inverter 134 controls the flow of current from the generator 114 based on current commands. The inverter 134 may include one or more switches (not shown) for carrying out the conversion. The switches may include one or more of Insulated-Gate-Bipolar-Transistors (IGBTs), Metal-Oxide-Semiconductor-Field-Effect-Transistors (MOSFETs), Gate-Turn-Off devices (GTOs), Silicon-Controlled-Rectifiers (SCRs), and the like. Further, the switches may be controlled by one or more pulse-width-modulated (PWM) signals. In certain embodiments, the PWM signals may correspond to current commands from an external source, such as the controller 120. In other embodiments, the PWM signals may correspond to current commands translated by a controller, processor, application specific integrated circuit (ASIC), or the like of the inverter 134.

The HVDC unit 130 suitably transforms the high frequency AC of the conversion unit 128 to HVDC power for distribution over the HVDC utility grid and/or distribution line 126. The high frequency AC power of the conversion unit 128 typically includes a low voltage or a medium voltage relative to the high voltage of the HVDC power. A voltage is low is typically 1 V to 1 kV, a medium voltage is typically 1 kV to 38 kV, and a high voltage is typically 38 kV and up. The transformation performed by the HVDC unit 130 suitably includes stepping up the high frequency AC power and transforming it to the HVDC power. In certain embodiments, the high frequency AC power of the conversion unit 128 may be stepped up to voltage levels ranging from 50 kV to 125 kV AC or more.

Additionally, as shown in FIG. 2, the HVDC unit 130 may include one or more of a transformer 136, one or more rectifiers 138, and the like. The transformer 136 suitably steps up the high fixed frequency AC power to a high voltage, high fixed frequency power. The transformer 136 is operated at the frequency of the high frequency AC power, which is typically on the order of kilohertz, but may be even larger, such as on the order of megahertz. The high frequency of the high frequency AC power allows the transformer 136 to be smaller than it would need to be if the AC power of the conversion unit 128 included a lower frequency, since there is less need for steel laminations required for operating at the 50 and/or 60 Hz of a standard line synchronized transformer. The rectifier(s) 138 suitably convert the high voltage, high frequency AC power to the HVDC power, which may then be provided to the HVDC utility grid and/or distribution line 126.

The accessory power system 118 provides power to components 140 of the wind turbine 100, such as turbine motors, pumps, fans, and the like. The power provided to the components 140 is suitably received from an external power source (not shown) via an accessory utility grid and/or supply line 142. Further, the power received from the external power source is suitably independent from power flowing through the primary power system 116 and/or the HVDC utility grid and/or distribution line 126. Even more, the power received from the external power source is suitably three phase, low voltage AC power. As above, the voltage is low in the sense that it is at least one order of magnitude lower than the voltage of the HVDC power. The external power source may include one or more of backup batteries, an AC utility grid, a DC utility grid, and the like.

In certain embodiments, the accessory power system 118 may further transform the voltage of the received power as necessary to power the components 140 of the wind turbine 100. To do so, the accessory power system 118 suitably includes a transformer 144 that lowers and/or raises the voltage of the power received from the external power source to the operating range required by the components 140. As noted above, the received power is typically AC, but DC is contemplated. Insofar as the received power is AC, the power is used directly to power ones of the components 140 requiring AC power, such as pumps, motors, fans, and the like. Further, the power is optionally converted to DC as necessary to power ones of the components 140 requiring DC power, whereby the accessory power system 118 may further include an AC-to-DC converter (not shown), such as a rectifier, inverter, or the like.

The accessory power system 118 is typically required because the flow of power from the HVDC utility grid and/or distribution line 126 is typically unidirectional and flows only from the generator 114 to the HVDC utility grid and/or the HVDC distribution line 126. This is to be contrasted with typically wind turbines. As such, when the generator 114 is not functioning due, for example, to the wind not blowing, power will generally not flow through the primary power system 116 and/or will generally not be received from the HVDC utility grid and/or distribution line 126. While the power generated by the generator 114 may be employed to charge any batteries which may be electrically connected to the wind turbine 100, in most embodiments this will be insufficient to power the components 140 of the wind turbine 100.

The controller 120 suitably performs one or more of keeping the wind turbine 100 pointed into the wind, monitoring for fault conditions, and operating fans, pumps and other components required to operate the wind turbine 100. Further, the controller 120 suitably controls the speed of the hub or rotor 110 based on a torque and/or speed curve for operation of the wind turbine 100 in varying wind conditions. The torque and/or speed curve is suitably provisioned to maintain the fixed voltage of the conversion unit 128. In certain embodiments, it is contemplated that a feedback loop is employed to match dynamically adjust the torque and/or speed curve. This feedback loop may, for example, provide the controller 120 with data as to the torque, speed, current flow, or the like of the wind turbine 100.

To vary the speed of the hub or rotor 110, the controller 120 controls the rotor blades 108 via pitch commands and/or controls the flow of current from the generator 114 via current commands. The current commands are suitably provided to the conversion unit 128 to control the high frequency inverter 134 or the active rectifier, depending upon the particular embodiment. Controlling the flow of current from the generator 114 affects the torque and/or speed of the hub or rotor 110 since the current flowing from the generator 114 is directly related to the torque of the wind turbine 100. For more information pertaining to this relation, attention is directed to U.S. Pat. No. 7,042,110, incorporated herein by reference, in its entirety.

In certain embodiments, the controller 120 may include a digital/electronic processor, such as a microprocessor, microcontroller, a programmable logic controller (PLC), and the like. In such embodiments, the controller 120 suitably executes instructions stored on a memory. In certain embodiments, the memory may be external to the controller and include one or more of a magnetic disk or other magnetic storage medium; an optical disk or other optical storage medium; a random access memory (RAM), read-only memory (ROM), or other electronic memory device or chip or set of operatively interconnected chips; and the like. In other embodiments, the memory may be local to the controller 120 and one of ROM, EPROM, EEPROM, Flash memory, and the like.

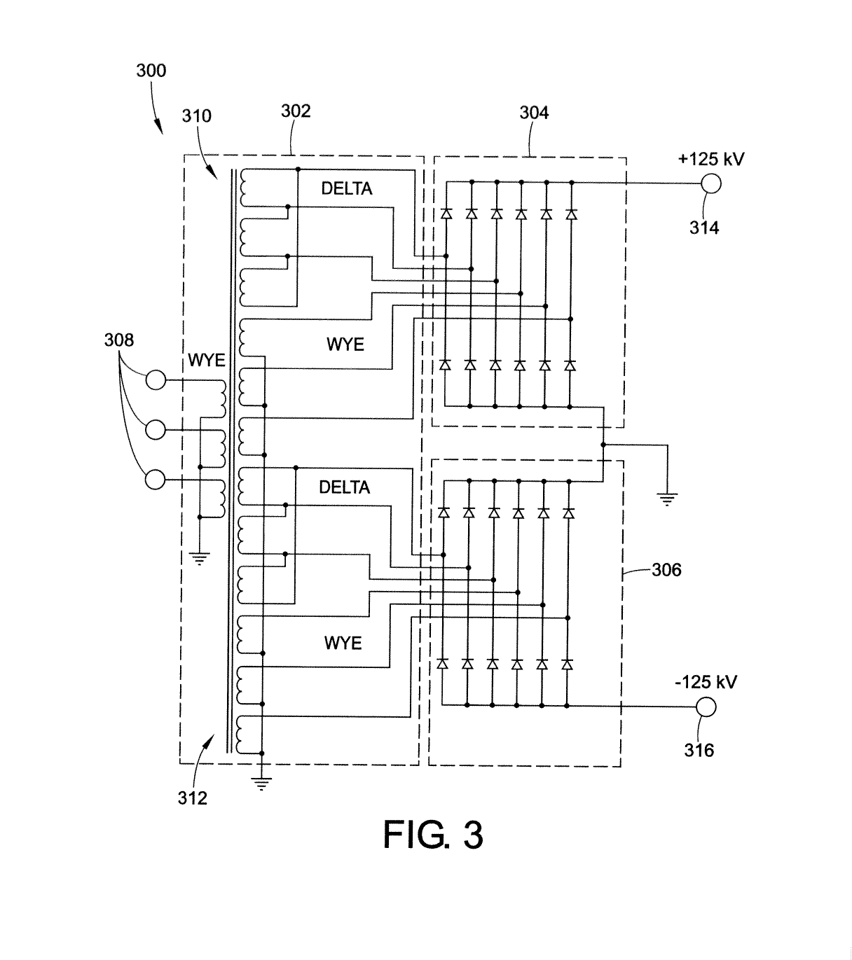

With reference to FIG. 3, a schematic view of an HVDC unit 300 according to aspects of the present disclosure is provided. The HVDC unit 300 is a more specific embodiment of the HVDC unit 130 of FIG. 1. Therefore, the discussion heretofore is equally amenable to the discussion to follow and components described hereafter are to be understood as paralleling like components discussed heretofore, unless noted otherwise. The HVDC unit 300 may include one or more of a transformer 302, a first rectifier 304, a second rectifier 306, and the like.

The transformer 302 of the HVDC unit receives a high fixed frequency AC power from an external component 308, such as the conversion unit 128, and steps it up to a higher voltage level. High voltage may, for example, range from 50 kV to 250 kV total or from +/−25 kV to +/−125 kV typical. Further, the power received from the external component 308 may include a single phase connection, a three phase connection or other multi multiphase connections. For example, three phases (as shown) may be received from the external component 308. In certain embodiments, the transformer 302 may include a first set of four output windings 310 combined in pairs to the first rectifier 304 and a second set of four output windings 312 combined in pairs to the second rectifier 306. Each of the output windings may be rated at, for example, 50 kV. In other embodiments, the transformer 302 may include a single output winding, rated at, for example, 250 kV, for each of the first rectifier 304 and the second rectifier 306.

The first rectifier 304 and the second rectifier 306 suitably convert the high voltage, high fixed frequency power of the transformer 302 to a first HVDC power 314 and a second HVDC power 316, respectively. Suitably, the first rectifier 304 and the second rectifier 306 receive the high voltage, high fixed frequency power via, for example, the first set of four output windings 310 and the second set of four output windings 312. The first rectifier 304 and/or the second rectifier 306 may comprise 12 pulse rectifiers (as shown), but other quantities and types of rectifiers are equally amenable. Further, the first rectifier 304 and the second rectifier 306 may be connected in series with a center ground tap to obtain HVDC. In certain embodiments, the first HVDC power 314 and the second HVDC power 316 may range from 100 kV to 125 kV and from −125 kV to −100 kV, respectively.

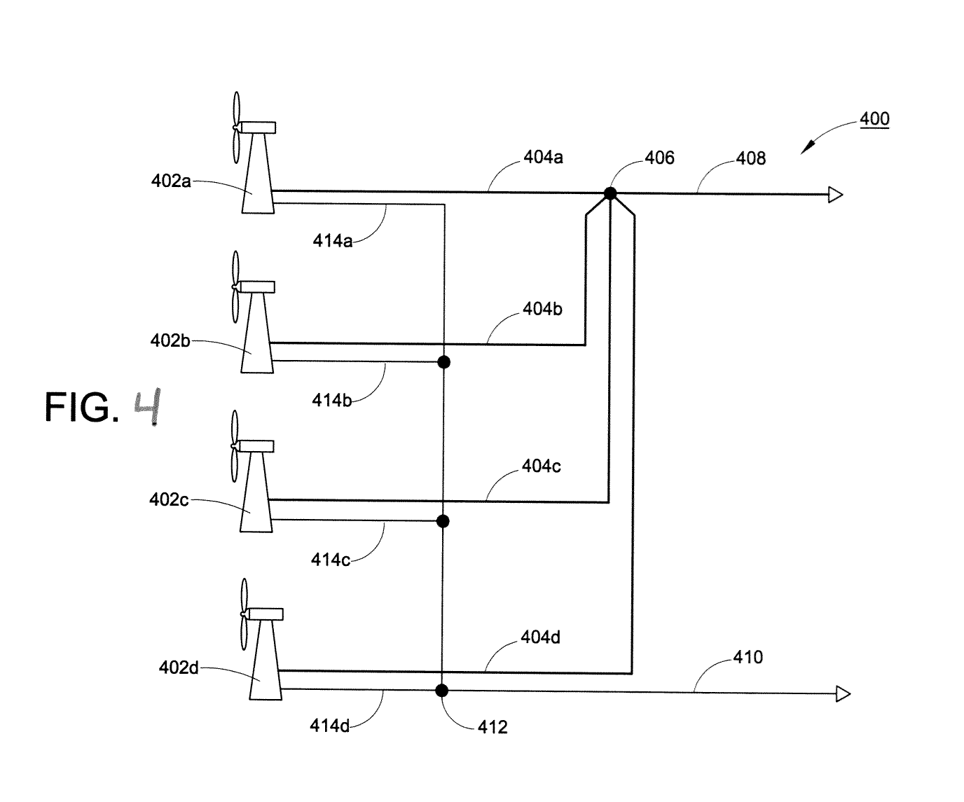

With reference to FIG. 4, a schematic view of a wind park 400 according to one embodiment of the present disclosure is illustrated. The wind park 400 is suitably located a long distance from any major population center and/or off shore so as to fully realize the benefits of HVDC. Further, the wind park 400 suitably includes a plurality of wind turbines 402, such as four wind turbines, where each of the wind turbines 402 is an embodiment of the wind turbine 100 of FIG. 1. The HVDC power outputs 404 of the wind turbines 402 are suitably connected in parallel to define a single feeder 406, where the feeder 406 is typically connected to an HVDC distribution line 408. The feeder 406 includes a positive terminal (not shown) and/or a negative terminal (not shown), along with a standard ground return (not shown). At the voltage level shown in FIG. 3 (i.e., 250 kilovolts) the wind farm 400 may be located miles from its load center and take advantage of low loss transmission offered by HVDC. Additionally, once the HVDC distribution line 408 is terminated, it may be connected to a utility grid in any part of the country or the world. In certain embodiments, when the utility grid is an AC utility grid, this entails transforming the HVDC to high voltage AC (HVAC) and synchronizing the HVAC with a synchronization source, such as the utility grid.

Also shown in FIG. 4 is an accessory distribution line 410 interfacing with an accessory utility grid and/or power source (not shown). The accessory distribution line 410 connects with a medium voltage (typically 1 kV to 38 kV) feeder 412 and suitably provides AC power thereto. The feeder 412 is used to supply each of the wind turbines 402 with accessory power 414. As noted above, the wind turbines 402 may use transformers to step the voltage of the power received from the accessory distribution line 410 down to a low voltage level, such as 480 VAC in the United States or 690 VAC in Europe. The accessory power 414 is suitably three phase, but single phase operation or other multiphase operation is contemplated. Further, the accessory power 414 suitably allows each of the wind turbines 402 to operate when the power output of the wind turbines 402 is not available for powering corresponding components and/or is insufficient or powering corresponding components due to, for example, low wind.

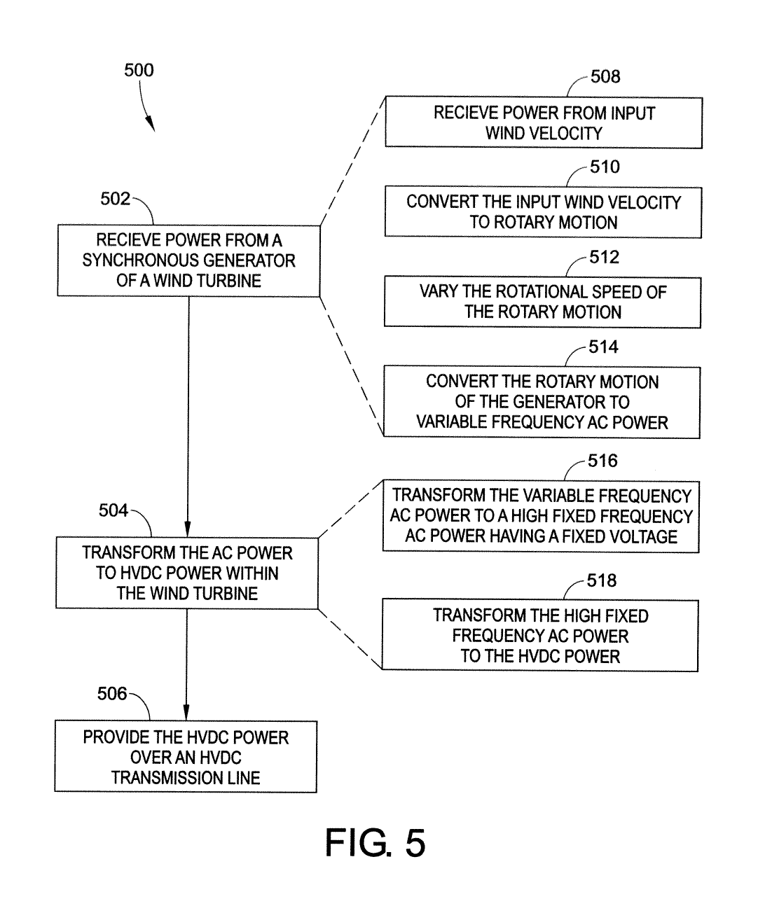

With reference to FIG. 5, a block diagram is shown of a method 500 of generating HVDC power for a wind turbine according to an embodiment of the present disclosure. The wind turbine is suitably an embodiment of the wind turbine 100 of FIG. 1. AC power is received 502 from a synchronous generator of the wind turbine and the generator's AC power is transformed 504 to HVDC power within the wind turbine. The synchronous generator may include one or more of a wound field synchronous generator where an exciter field is excited with a constant current and a permanent magnet synchronous generator. The HVDC power is then provided 506 over an HVDC transmission line.

The receipt 502 of the AC power from the synchronous generator suitably includes receiving 508 power from input wind velocity, which is then converted 510 to rotary motion using one or more rotor blades attached to a hub or rotor of the wind turbine. Optionally, the rotational speed of the rotary motion is varied 512 via a gearbox of the wind turbine to that required by the synchronous generator of the wind turbine. Regardless of whether the rotational speed is varied 512 by the gearbox, the rotary motion is converted 514 to the AC power using the generator.

The transformation 504 of the AC power to the HVDC power suitably includes transforming 516 the generator's variable frequency AC power to a high frequency AC power having a fixed voltage and a fixed frequency. The fixed voltage is typically a standard low voltage output, such as 480V, 575V, and 690V, or a standard medium voltage, such as 2,400V, 3,300V and 4,160V. The transformation of the AC power to the high frequency AC power having the fixed voltage suitably includes converting the AC power to a DC power using a rectifier and converting the DC power to the high frequency AC power using an inverter.

Further, the transformation of the AC power to the high frequency AC power having the fixed voltage suitably includes maintaining the fixed voltage by controlling the speed of the hub or rotor of the wind turbine based on a torque and/or speed curve. This may include controlling the flow of current from the synchronous generator and/or controlling the rotor blades to maintain the fixed voltage. As to the former, Ohm's law dictates that if the load increases, the current will need to increase to maintain the fixed voltage. As another example, if the load decreases, the current will need to decrease to maintain the fixed voltage. Suitably, control the speed of the hub or rotor is actively performed with the aid of a feedback loop and a processor, such as a microcontroller, microprocessor, programmable logic controller or other embedded type of programmable system controllers.

The transformation 504 of the generator's variable frequency AC power to the high fixed frequency AC power having the fixed voltage further includes transforming 518 the high frequency AC power to the HVDC power. Preferably, the transformation of the high frequency AC power to the HVDC power includes converting the high frequency AC power to a high voltage, high frequency AC power using a transformer and converting the high voltage, high frequency AC power to the HVDC power using one or more rectifiers.

The provisioning 506 of the HVDC power over an HVDC transmission line suitably includes providing the HVDC power to an HVDC utility grid. The HVDC utility grid is suitably distant so as to maximize the benefits of HVDC as compared to traditional AC power distribution schemes. Notably, the HVDC transmitted over the HVDC transmission line typically includes a unidirectional flow away from the wind turbine since the flow of power from the synchronous generator is actively regulated, as described above, and generally rectified before distribution. As a consequence, the wind turbine may generally not receive power from the HVDC distribution line.

In the event of a lack of internal power from the synchronous generator, the method 500 may further include receiving (not shown) power from an external power source independent from the HVDC transmission line at an accessory power system and providing (not shown) the power received from the external power source to components of the wind turbine. The receipt of power from an external power source independent from the HVDC transmission line suitably entails receiving power from a utility grid, battery backups, and the like. The received power may be AC or DC so long as it is independent from the HVDC utility grid and/or distribution line.

The provisioning of the power received from the external power source to components of the wind turbine is suitably used to maintain the wind turbine in an operating state when the wind turbine is not generating power. Because the flow of power over the HVDC distribution is generally unidirectional away from the wind turbine, the wind turbine may not power components from power received from the HVDC distribution line. Consequently, without power from the external power source, the wind turbine would only have power from the synchronous generator to power components.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A wind turbine comprising:
a synchronous generator that converts rotary motion of a hub or rotor of he wind turbine to variable frequency alternating current (AC) power; and,
a primary power system located within the wind turbine that transforms the variable frequency AC power to high voltage direct current (HVDC) power and provides the HVDC power to a load over an HVDC transmission line.

2. The wind turbine of claim 1, wherein the synchronous generator is one of a permanent magnet synchronous generator and a wound field synchronous generator.

3. The wind turbine of claim 1, wherein the primary power system includes:
a conversion unit that transforms the variable frequency AC power to high fixed frequency AC power, wherein the frequency of the high fixed frequency AC power is at least one order of magnitude greater than a highest frequency of the variable frequency AC power; and,
a HVDC unit that transforms the high fixed frequency AC power to the HVDC power, wherein the voltage of the HVDC power at least 38 kV.

4. The wind turbine of claim 3, wherein the high fixed frequency AC power includes a fixed voltage, said wind turbine further comprising:
a controller that maintains the fixed voltage by controlling a speed of the hub or rotor.

5. The wind turbine of claim 4, wherein the speed of the hub or rotor of the wind turbine is controlled by controlling the flow of current from the generator and/or controlling pitch of rotor blades attached to the hub or rotor.

6. The wind turbine of claim 1, wherein the primary power system includes:
a rectifier that converts the variable frequency AC power to DC power;
a high frequency inverter that converts the DC power to high fixed frequency AC power, wherein the frequency of the high frequency AC power is at least one order of magnitude greater than the frequency of a highest frequency of the variable frequency AC power;
a transformer that converts the high fixed frequency AC power to high voltage, high frequency AC power, wherein the voltage of the high voltage, high frequency AC power is at least 38 kV; and,
one or more rectifiers that convert the high voltage, high fixed frequency AC power to the HVDC power.

7. The wind turbine of claim 6, wherein the high fixed frequency AC power includes a fixed voltage, said wind turbine further comprising:
a controller that maintains the fixed voltage by controlling a speed of the hub or rotor.

8. The wind turbine of claim 6, wherein the rectifier(s) that convert the high voltage, high fixed frequency AC power to the HVDC power include one or more multi-pulse rectifiers.

9. The wind turbine of claim 1, wherein power flow through the primary power system is unidirectional and away from the generator.

10. The wind turbine of claim 1, further comprising:
an accessory power system that provides power to components of the wind turbine, wherein the accessory power receives the power from an external power source independent from the HVDC transmission line.

11. A method of generating high voltage direct current (HVDC) power from a wind turbine, said method comprising:
receiving variable frequency alternating current (AC) power from a synchronous generator of the wind turbine, wherein the generator converts rotary motion of a hub or rotor of the wind turbine to the AC power;
transforming the variable frequency AC power to HVDC power within the wind turbine; and,
providing the HVDC power to an HVDC transmission line.

12. The method of claim 11, wherein the synchronous generator is one of a permanent magnet synchronous generator and a wound field synchronous generator.

13. The method of claim 11, wherein the transforming includes:
transforming the variable frequency AC power to high fixed frequency AC power having a fixed voltage, wherein the frequency of the high fixed frequency AC power is at least one order of magnitude greater than a highest frequency of the variable frequency AC power; and,
transforming the high fixed frequency AC power to the HVDC power, wherein the voltage of the HVDC power is at least 38 kV.

14. The method of claim 13, wherein the high fixed frequency AC power includes a fixed voltage, said method further comprising:
maintaining the fixed voltage by controlling a speed of the hub or rotor.

15. The method of claim 14, wherein the control of the speed of the hub or rotor includes controlling the flow of current from the generator and/or controlling pitch of rotor blades attached to the hub or rotor.

16. The method of claim 11, wherein the transforming includes:
converting the variable frequency AC power to DC power using a rectifier;
converting the DC power to high fixed frequency AC power using an inverter, wherein the frequency of the high frequency AC power is at least one order of magnitude greater than a highest frequency of the variable frequency AC power;
converting the high fixed frequency AC power to a high voltage, high fixed frequency AC power using a transformer, wherein the voltage of the high voltage, high fixed frequency AC power is at least 38 kV; and,
converting the high voltage, high fixed frequency AC power to the HVDC power using one or more rectifiers.

17. The method of claim 16, further comprising:
maintaining the fixed voltage by controlling a speed of the hub or rotor.

18. The method of claim 16, wherein the rectifier(s) used to convert the high voltage, high fixed frequency AC power to the HVDC power include one or more multi-pulse rectifiers.

19. The method of claim 11, further comprising:
receiving power from an external power source independent from the HVDC transmission line; and,
providing the power received from the external power source to components of the wind turbine.

20. A wind park comprising:
a plurality of wind turbines, wherein each of the wind turbines includes:
a synchronous generator that converts rotary motion of a hub or rotor of the each of the wind turbines to variable frequency alternating current (AC) power; and,
a primary power system located within the each of the wind turbines that transforms the variable frequency AC power of the each of the wind turbines to high voltage direct current (HVDC) power; and,
a feeder that receives the HVDC power from the each of the wind turbines and feeds the received HVDC power to an HVDC transmission line.
